(19) United States
(12) Patent Application Publication
(10) Pub. No.: US 2026/0163788 A1
(43) Pub. Date: Jun. 11, 2026

(54) CONFIGURATION SETTING REUSE IN A WIRELESS NETWORK

(71) Applicant: Charter Communications Operating, LLC, St. Louis, MO (US)

(72) Inventor: Timothy Clark Bleidorn-Piper, Colorado Springs, CO (US)

(21) Appl. No.: 18/976,795

(22) Filed: Dec. 11, 2024

(51) Int. Cl. H04L 41/0663; H04W 40/02

(52) U.S. Cl. CPC H04L 41/0663; H04W 40/02

(57) ABSTRACT

A wireless system as discussed herein includes a communication management resource configured to provide a first mobile communication device access to a remote network over a first communication path through a first wireless access point, where the first mobile communication device is wirelessly connected to the first wireless access point. The communication management resource is further configured to obtain first configuration settings associated with the first communication path and corresponding first gateway resource. The communication management resource then utilizes the first configuration settings to provide the first mobile communication device access to the remote network over a second communication path. For example, the communication management resource communicates the first configuration settings to a second gateway resource associated with the second communication path. The second communication path supports backup conveyance of communications during conditions in which the first communication path is unavailable.

### BACKGROUND

In a VCP (Virtual Customer Premises) network architecture, broadband network gateways (a.k.a., BNGs) are used as the termination point for connected LANs (Local Area Networks), where a respective wireless access point may implement one or more local area networks. The one or more local area networks associated with a wireless access point may be tunneled over GRE (Generic Routing Encapsulation) to the BNG (Broadband Network Gateway), carrying the two frames of the user equipment directly to the routing process on the BNG, where the BNG serves as the router as well as the network address translation point to the privately address user equipment to a publicly routable IPV (Internet Protocol Version) network address.

### BRIEF DESCRIPTION OF EXAMPLES

Today, conventional networks can be configured to deploy redundant broadband network gateways to serve a single market. For example, a network environment can be configured to include a first communication path between the wireless access point and a first broadband network gateway providing access to a remote network. The network environment also can be configured to include a second communication path between the wireless access point and a second broadband network gateway providing access to the remote network. Thus, if the primary BNG fails, the secondary BNG can be configured to take over and provide continued access to the respective user equipment through the wireless access point. The continued use requires the conventional secondary BNG to utilize different network addresses, different network address translation settings, different pool of addresses, different port information, etc., than the primary BNG to support the backup communications.

This disclosure includes the observation that there are deficiencies associated with implementing a conventional secondary BNG (Broadband Network Gateway) to manage traffic flow (transmission of data packets) on behalf of user equipment as previously discussed. For example, when the conventional secondary BNG takes over management of the connection requests (request for data by the user equipment) such as due to a failure of the primary BNG, the conventional secondary BNG will utilize, according to conventional techniques, a different network address, translation, pool of addresses, etc., to support the backup communications. In such an instance, in the conventional case, all of the connections (such as primary paths to the primary BNG) that existed prior to the link transfer will need to be reset for the secondary paths to the secondary BNG in order to support the further traffic flow on behalf of the user equipment. This means that any switchover from a primary network path to a secondary network path during a failover condition will be a disruptive experience for the user because the user will be unable to access the remote network for a certain amount of time during the reestablishment of appropriate settings.

In contrast to the conventional techniques, in general, the examples as discussed herein include use of an externalized network address translation server to be instantiated with respect to the BNGs via the use of either a layer two network segment between each of the BNGs and the NAT (Network Address Translator) resource or tuning of the privately addressed UI (User Identity) traffic northbound (such as into a public network) of the BNGs with respect to the network address translation resource. Such a configuration sharing configuration settings (such as port mapping information or other information assigned to the user equipment for the first communication path) supports a BNG switchover to occur while maintaining the translated bindings for each instance of user equipment, providing a seamless failover from one communication path to another in the event of the loss of one of the BNGs.

In other words, as discussed herein, sharing of configuration settings are configuration information amongst multiple different gateway resources provides seamless switchover of a wireless access point and smooth transition to use of a second communication path as a substitute to a first communication path during a condition in which the first communication path is unavailable.

More specifically, as discussed herein, a wireless network service provider and corresponding executed communication hardware and software provide a first mobile communication device access to a remote network over a first communication path through a first wireless access point, where the first mobile communication device is wirelessly connected to the first wireless access point. To support switchover to a second communication path as discussed herein, the communication management resource obtains first configuration settings associated with the first communication path. The communication management resource then uses the first configuration settings to provide the first mobile communication device access to the remote network over a second communication path.

In one example, the communication management resource can be configured to obtain the first configuration settings via receipt of a unique identity value assigned to the first mobile communication device. The communication management resource can be configured to map the unique identity value to the first configuration settings used by a first gateway resource in the first communication path to the first configuration settings. The communication management resource can be configured to transmit the first configuration settings to a second gateway resource in the second communication path. The second gateway resource then the first configuration settings as a basis in which to implement the second communication path and, thus, provide the first mobile communication device access to the remote network using the second communication path during conditions in which the first communication path is unavailable.

In another example, the second communication path may be a backup communication path with respect to the first communication path for use during a condition in which the first communication path is unable to support sufficient conveyance of data traffic on behalf of the first mobile communication device. Yet further, note that the first configuration settings may be applied by a first gateway resource in the first communication path to support the access to the remote network. The communication management resource may receive a query from a second gateway resource supporting the second communication path. In response to receiving the query, the communication management resource can be configured to notify the second gateway resource to provide the first mobile communication device access through the second communication path using the first configuration settings.

In still another example, the first communication path can be configured to include or be a first secure network tunnel between the first wireless access point and the first gateway resource. The second communication path can be configured to include or be a second secure network tunnel between the first wireless access point and the second gateway resource. The first configuration settings may include any suitable information supporting conveyance of data packets in the network environment. In one example, the first configuration settings include or indicate at least one port number in which to forward the communications on behalf of the first mobile communication device to the remote network. As previously discussed, the second communication path can be used as a backup communication path with respect to the first communication path during a condition in which the first communication path is unavailable for use by the mobile communication device. The at least one port number associated with the first configuration settings also can be used to support conveyance of communications over the second communication path through the second gateway resource to a remote network.

In accordance with still further examples as discussed herein, the first configuration settings can be configured to indicate a first pool of port numbers assigned to the first mobile communication device, where the first pool of port numbers is assigned for use by a first gateway resource associated with the first communication path. The communication management resource supplies the first pool of port numbers and corresponding mapping information to a second gateway resource associated with the second communication.

In a further example, the communication management resource receives notification including an identity of a first mobile communication device wirelessly connected to a first wireless access point. The first wireless access point provides the first mobile communication device access to a remote network over a first communication path and corresponding first gateway. In response to receiving the notification, the communication management resource or other suitable entity maps the identity of the first mobile communication device to an identity of a first gateway resource or corresponding first configuration settings supporting the first communication path. Based on the mapping and determination of the first configuration settings assigned to the first communication path associated with the first wireless access point and potentially the first mobile communication device, the communication management resource communicates the first configuration settings to a second gateway resource supporting a second communication path. Via the first configuration settings, the second gateway resource and corresponding second communication path provide the first mobile communication access to the remote network over the second communication path between the wireless access point and the remote network such as during conditions when the first communication path is unavailable.

In further examples, it is noted that the synchronization of the first configuration settings used by both the first gateway resource and the second gateway resource ensure that a public identity associated with data packets forwarded from the first gateway resource and the second gateway resource appear to the public network as being the same.

In yet another example, the communication management resource as discussed herein receives a notification including an identity of a first mobile communication device wirelessly connected to a first wireless access point, where the first wireless access point provides the first mobile communication device access to a remote network over a first communication path. In response to receiving the notification, the communication management resource maps the identity of the first mobile communication device to an identity of a first gateway resource supporting the first communication path. Based on the mapping, the communication management resource determines configuration settings associated with the first gateway resource and communicates the configuration settings to a second gateway resource in order to provide the first mobile communication access to the remote network over a second communication path (backup communication path supported by the second gateway resource) between the wireless access point and the remote network.

As previously discussed, techniques as discussed herein are useful over conventional techniques. For example, one or more implementation of the communication system and corresponding operations as discussed herein provide better connectivity between users and corresponding user equipment and a remote network.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are also directed to a method, system, computer program product, etc., that supports operations as discussed herein.

One example as further discussed herein includes a computer readable storage medium and/or system having instructions stored thereon. The instructions, when executed by the computer processor hardware, cause the computer processor hardware (such as one or more co-located or disparately processor devices or hardware) to: provide a first mobile communication device access to a remote network over a first communication path through a first wireless access point, the first mobile communication device wirelessly connected to the first wireless access point; obtain first configuration settings associated with the first communication path; and utilize the first configuration settings to provide the first mobile communication device access to the remote network over a second communication path.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless connectivity in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more inventive concepts as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment and implementation of one or more wireless access points providing multiple different communication devices wireless connectivity to a remote network as discussed herein.

FIG. 2 is an example diagram illustrating operations associated with establishing a first communication path to provide a respective mobile communication device access to a remote network as discussed herein.

FIG. 3 is an example diagram illustrating operations associated with establishing a second communication path to provide the respective mobile communication device backup access to a remote network as discussed herein.

FIG. 4 is an example diagram illustrating implementation of a first communication path and corresponding gateway resource to provide a mobile communication device access to a remote network as discussed herein.

FIG. 5 is an example diagram illustrating implementation of a second communication path and corresponding gateway resource to provide the mobile communication device access to a remote network during a failure of the first communication path and/or the first gateway resource as discussed herein.

FIG. 6 is an example diagram illustrating configuration settings supporting communication of data packets through multiple debris resources as discussed herein.

FIG. 7 is an example diagram illustrating use of the configuration settings to support conveyance of data packets over a combination of a first communication path and a first gateway resource to a remote network as discussed herein.

FIG. 8 is an example diagram illustrating use of the configuration settings support conveyance of data packets over a combination of a second communication path and a second gateway resource to a remote network as discussed herein.

FIG. 9 is an example diagram illustrating example computer hardware and software operable to execute operations as discussed herein.

FIG. 10 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

A wireless system as discussed herein includes a communication management resource configured to provide a first mobile communication device access to a remote network over a first communication path through a first wireless access point, where the first mobile communication device is wirelessly connected to the first wireless access point. The communication management resource is further configured to obtain first configuration settings associated with the first communication path and corresponding first gateway resource. The communication management resource then utilizes the first configuration settings to provide the first mobile communication device access to the remote network over a second communication path. For example, the communication management resource communicates the first configuration settings to a second gateway resource associated with the second communication path. The second communication path supports backup conveyance of communications during conditions in which the first communication path is unavailable.

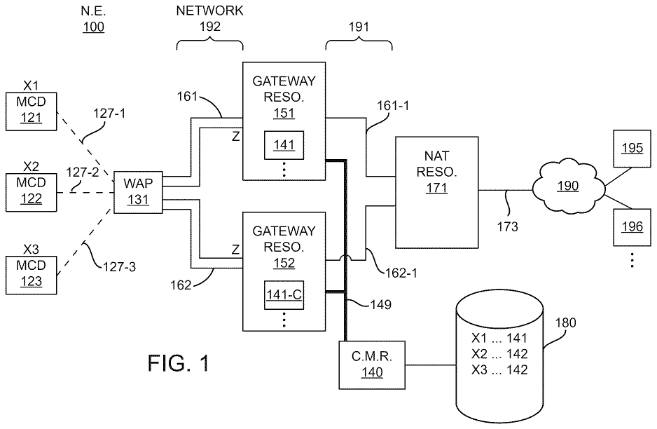

Now, more specifically, FIG. 1 is an example diagram illustrating a network environment and implementation of one or more wireless access points and corresponding one or more communication paths to provide multiple different communication devices connectivity to a remote network as discussed herein.

As shown in FIG. 1, the network environment 100 includes mobile communication device 121, mobile communication device 122, mobile communication device 123, etc., wireless access point 131, gateway resource 151, gateway resource 152, network address translator resource 171, communication management resource 140, repository 180, network 190, server resource 195, server resource 196, etc.

Note that the network address translator resource 171 may be integrated into each of the corresponding gateway resource 151 and gateway resource 152.

As further shown, the mobile communication device 121 (such as operated by a first user and assigned the unique network address value X1 such as network address 192.168.1.10) is wirelessly connected to the wireless access point 131 via wireless communication link 127-1; the mobile communication device 122 (such as operated by a second user and assigned the unique network address value X2) is wirelessly connected to the wireless access point 131 via wireless communication link 127-2; the mobile communication device 123 (such as operated by a third user and assigned the unique network address value X3) is wirelessly connected to the wireless access point 131 via wireless communication link 127-3; and so on.

As further shown, the wireless access point 131 is in communication with the gateway resource 151 via the communication path 161. The wireless access point is in communication with the gateway resource 152 via the communication path 162.

Accordingly, the wireless access point 131 serves as a terminating node for the user equipment (such as mobile communication device 121, mobile communication device 122, mobile communication device 123, etc.). The wireless access point 131 also serves as a terminating node for the communication path 161 such as a secure tunnel extending between the wireless access point 131 and the gateway resource 151 (such as a so-called broadband network gateway or other suitable entity).

The wireless access point 131 also serves as a terminating node for the communication path 162 such as a second secure tunnel extending between the wireless access point 131 and the gateway resource 152 (such as a so-called broadband network gateway or other suitable entity).

The communication path 161 and communication path 162 can be implemented in the network 192. The network 192 can include any suitable resources (such as routers, links, etc.) supporting conveyance of a respective communications between the wireless access point 131 and the gateway resources 151 and 152. In one example, the gateway resource 151 is assigned the unique network address Z; the gateway resource 152 is also assigned the same unique network address Z.

The network 192 and corresponding communication path 161 can be configured to support conveyance (such as routing) of communications (having a destination network address Z) transmitted from the wireless access point 131 to the gateway resource 151 via the first communication path 161 during first conditions when there is no failure associated with the communication path 161 and gateway resource 151. In other words, when there is no failure, during a first condition, the network 192 automatically supports conveyance of communications through the wireless access point 131 to the gateway resource 151.

However, during a second condition, such as a failure condition when the first communication path 161 or the gateway resource 151 is unavailable, the network 192 automatically switches over to transmitting communications (destined for delivery to the network address Z) from the wireless access point 131 over the second communication path 162 to the gateway resource 152. In such an instance, both the gateway resource 151 and the gateway resource 152 can be assigned the unique network address value Z, while the network itself 192 supports automatic switchover from one communication path to the other depending upon a link quality associated with each of the communication path 161 and the communication path 162.

Thus, the second communication path 162 can be used as a backup in the event that the primary gateway resource 151 or the communication path 161 experiences a respective failure. The communication path 161 and corresponding gateway resource 151 can be configured to service all content requests from wireless access point 131 and potentially other wireless access points in the network environment 100 while the communication path 162 and the gateway resource 152 potentially sit idle. As further discussed herein, the second gateway resource 152 and corresponding communication path 162 can be configured to take over providing conveyance of communications between the wireless access point 131 and the gateway resource 152 in the event of the failure of the primary gateway resource 151 terminating the secure tunnels (such as communication path 161 and communication path 162) from the respective wireless access point 131.

Yet further, each of the gateway resource 151 and the gateway resource 152 are in communication with the network address translator resource 171. As further discussed herein, the network address translator 171 may be integral to the gateway resource 151 and gateway resource 152.

More specifically, during operation, the gateway resource 151 is in communication with the network address translator resource 171 via the communication path 161-1. The gateway resource 152 is in communication with the network address translator resource 171 via the communication path 161-2.

In one example, the primary gateway resource 151, when active, transmits user equipment generated data traffic such as data packets to the network address translator resource 171 for translation to a respective Public network address for routing to a respective destination (such as server resource 195, server resource 196, etc.) in the network 190. Note that the nature of the connection such as communication path 161-1 can be either layer two or layer three with the minimum requirement of IPP connectivity between the gateway resource 151 in the network address translator resource 171.

As previously discussed, the secondary gateway resource 152 uses the network address translator resource 171 in the event of failure of the primary gateway resource 151, where the synchronization of configuration settings (141) of the gateway resource 151 and the disposition of the internal networks enables the network address translator resource 171 to continue servicing current connections from the user equipment (121) seamlessly during a respective switch over.

The network address translator resource 171 provides access to the remote network 190 (such as a so-called public network, which may be the Internet). The one or more server resources 195, 196, etc., are accessible through the remote network 190. As its name suggests, the network address translator resource 171 supports translation of network addresses.

In a further example, the BNG control plane supported by the communication management resource 140 maintains a state of all connected networks and connected user equipment (such as configuration settings 141 such as including port information associated with the mobile communication device 121) to be synchronized between the primary gateway resource 151 and the secondary gateway resource 152 to facilitate seamless failover in the event of a failure associated with the communication path 161 or the gateway resource 151.

Note further that the BNG control plane 149 supported by the communication management resource 140 can also be used to track the lease state information of all the connected user equipment and associated the local area network identifiers indicating the internal network in case future redundant NAT functions are implemented.

Yet further, it is noted that the network address translation resource 171 can be configured to receive the privately IP value assigned to the respective user equipment, corresponding traffic from the user equipment, and translate the received traffic from the user equipment such as mobile communication device 121 into a publicly routable IPV network address using layer for port to multiplex the connections. If desired, tag numbers may be used to differentiate individual internal local area networks serviced by the respective gateway resource in order to facilitate the reuse of private subnet prefixes across multiple tenant networks. By assigning a virtual identifier or number to each individual internal network, the same IP prefix can be used across multiple networks serviced by the same gateway resource and still remain locally unique to the network address translation function implemented by the network address translator resource 171.

In accordance with one example, the gateway resource or BNG control plane 149 implemented by the communication management resource 140 is responsible for all of the management functions of the BNG user planes, including synchronizing connected state DHCP database information and system health.

Note further that the repository 180 can be configured as a subscriber database such as including repository 180 storing subscriber information used by the BNG control plane as a data store. The BNG control plane implemented by the communication management resource 140 can be configured to reference this subscriber database (information in the repository 180) and corresponding information when needed in order to pass synchronization instructions to BNG user plane.

In a further example, the communication management resource 140 is responsible for synchronizing the configuration settings 141 used by each of the gateway resources 151 and 152 to support communications associated with the mobile communication device 121. For example, the communication management resource 140 is responsible for updating the configuration settings 141 supplied/applied to each of the gateway resource 151 and the gateway resource 152 to provide seamless communication path switch over at any time. The configuration settings 141 and the configuration settings 141-C constantly updated by the communication management resource 140 such that they are identical (a.k.a., synchronized).

In a further example, the configuration settings 141 (network information) can be configured to include any suitable information. In one example, the configuration settings 141 represents a so-called “port pool” or port block including or specifying a group of available port numbers associated with communications supported by the mobile communication device 121. Each of the ports as indicated by the configuration settings 141 produced for the mobile communication device 121 and supportive communications through the gateway resource 151 may be assigned for use by a different application executed by the mobile communication device 121.

To ensure a seamless switchover during a condition in which the communication path 161 and corresponding gateway resource 151 are unavailable, the communication management resource 140 repeatedly updates the configuration settings assigned to the gateway resource 152 over time such that the gateway resource 151 in the gateway resource 152 are able to support conveyance of communications associated with the mobile communication device 121 assigned the unique network address identifier value X1.

Note that the resources as discussed herein can be implemented in any suitable manner. For example, the mobile communication device 121 can be implemented as communication hardware, communication software, or a combination of communication hardware and communication software; the wireless access point 131 can be implemented as wireless access point hardware, wireless access point software, or a combination of wireless access point hardware and wireless access point software; gateway resource 151 can be implemented as gateway hardware, gateway software, or a combination of gateway hardware and gateway software; gateway resource 152 can be implemented as gateway hardware, gateway software, or a combination of gateway hardware and gateway software; communication management resource 140 can be implemented as communication management hardware, communication management software, or a combination of communication management hardware and communication management software; and so on.

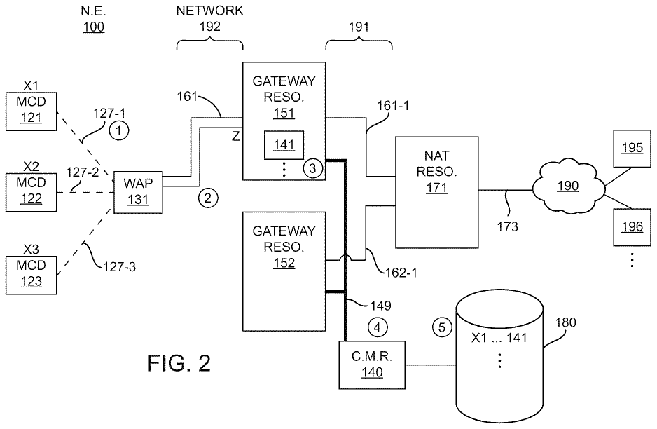

FIG. 2 is an example diagram illustrating operations associated with establishing a first communication path to provide a respective mobile communication device access to a remote network as discussed herein.

In processing operation #1, the mobile communication device 121 establishes the respective wireless communication link 127-1 between the mobile communication device 121 and the wireless access point 131. The wireless communication link 127-1 supports conveyance of data packets between the mobile communication device 121 and the wireless access point 131.

A combination of the wireless communication link 127-1, wireless access point 131, communication path 161, gateway resource 151 and network address translator resource 171 represent a first communication path supporting conveyance of communications between the mobile communication device 121 and the one or more server resources in the network 190.

In processing operation #2, on behalf of at least the mobile communication device 121, the wireless access point 131 establishes the communication path 161 (such as a secure tunnel) between the wireless access point 131 and the gateway resource 151. In one example, the communications (such as data packets) over the communication path 161 are encapsulated via any suitable protocol such as GRE (Generic Routing Encapsulation). In general, a GRE tunnel such as the communication path 161, is a virtual point-to-point connection between the wireless access point 131 and the gateway resource 151. Thus, the communication path 161 such as a tunnel can be configured to allow data packets to be encapsulated within other packets, essentially creating a secure communication path such as a tunnel. The encapsulation is generally a wrapper for the transmitted data packets, adding headers to identify the tunnel source (such as at the wireless access point 131) and destination (gateway resource 151) while preserving the original data packet content inside.

Further, in processing operation #3, the gateway resource 151 implements configuration settings 141 (network state information such as including port mapping information) on behalf of the mobile communication device 121 to support transmission and reception of data packets associated with the mobile communication device 121 through the gateway resource 151.

In processing operation #4, the communication management resource 140 is in communication with the gateway resource 151 via a management communication path (149) to receive the configuration settings 141 implemented by the gateway resource 151.

In processing operation #5, the communication management resource 140 stores the control settings 141 (network configuration settings including port information and mapping associated with the mobile communication device 121) in the repository 180.

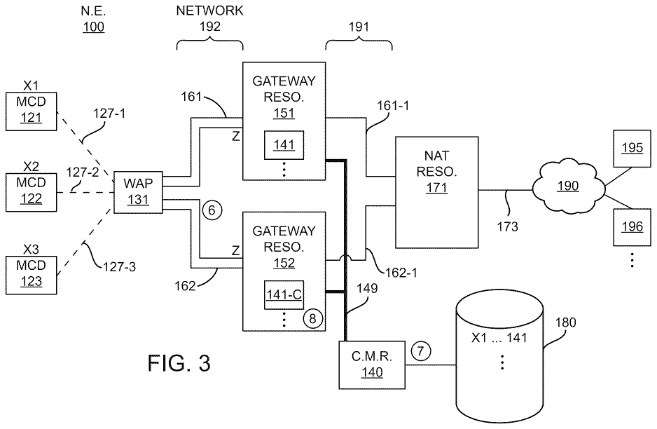

FIG. 3 is an example diagram illustrating operations associated with establishing a second communication path to provide a respective mobile communication device backup access to a remote network as discussed herein.

In processing operation #6, on behalf of at least the mobile communication device 121, the wireless access point 131 establishes the communication path 162 (such as a secure tunnel) between the wireless access point 131 and the gateway resource 152. In one example, the communications (such as data packets) over the communication path 162 are encapsulated via any suitable protocol such as GRE (Generic Routing Encapsulation). In one example, the communication path 162 is a virtual point-to-point connection between the wireless access point 131 and the gateway resource 152. Thus, the communication path 162 such as a tunnel can be configured to allow data packets to be encapsulated within other packets, essentially creating a secure communication path such as a tunnel. The encapsulation is generally a wrapper for the transmitted data packets, where the wrapper may include additional headers to identify the tunnel source (such as at the wireless access point 131) and destination (gateway resource 152) while preserving the original data packet content inside.

Note that a combination of the wireless communication link 127-1, wireless access point 132, communication path 162, gateway resource 152 and network address translator resource 171 represent a second communication path supporting conveyance of communications between the mobile communication device 121 and the one or more server resources in the network 190.

In processing operation #7, via the communication path 149 (such as a gateway resource control plane), the communication management resource 140 receives notification of the communication path 161 and corresponding gateway resource 151 set up for the mobile communication device 121 assigned the network address X1. The communication management resource 140 can be configured to receive a notification (message) such as from the wireless access point 131 or gateway resource 152 of the network address X1 assigned to the mobile communication device 121. As further discussed herein, the communication management resource 140 supports set up of the communication path 162 and gateway resource 152 as a backup communication path with respect to the first communication path as previously discussed. The second setup of the gateway resource 152 may include the communication management resource 140 mapping an identity of the mobile communication device 121 and, more specifically, the network address X1 to the corresponding configuration settings 141 implemented by the gateway resource 151. Further, in processing operation #7, the communication management resource 140 forwards or transmits the configuration settings 141 to the gateway resource 152. The gateway resource 152 stores the received configuration settings 141 as configuration settings 141-C (copy or replica of configuration settings 141 used by the gateway resource 151) to support subsequent conveyance of communications on behalf of the mobile communication device 121 during a backup condition when the communication path 162 and corresponding gateway resource 152 is used to provide connectivity of the mobile communication device 121 to the network 190 as an alternative to the communication path 161 and gateway resource 151.

Further, in processing operation #8, subsequent to set up of the communication path 162 and the gateway resource 152, the gateway resource 151 implements configuration settings 141-C (which, as previously discussed, is a copy of the configuration settings 141 such as network state information) on behalf of the mobile communication device 121 to support transmission and reception of data packets associated with the mobile communication device 121 through the gateway resource 152 during a condition in which the communication path 161 and corresponding gateway resource 151 are unavailable such as due to a failure.

As previously discussed, the synchronization of the configuration settings 141 used by both the gateway resource 151 and the gateway resource 152 over time enables a seamless switchover of communications associated with the mobile communication device 121 about to network 190 and inbound from network 190 because the same configuration settings 141 are used by both the gateway resource 151 and the gateway resource 152. Further, as previously discussed, the network 192 automatically handles failover of conveying data packets directed to the network address Z such that the appropriate active gateway resource (such as 151 or 152) receives the data packets to be forwarded to the remote network 190 through the network address translator resource 171. In other words, the network 192 forwards any communications from the wireless access point 131 to the gateway resource 152 during conditions in which the wireless access point 131 is unable to indicate those communications to the gateway resource 101. Because there is no glitch in conveying communications during a respective hand off from one communication path (161) to the other (162), or vice versa, the mobile communication device 121 and the network 190 may be unaware or is unaware of the hand off of using gateway resource 152 instead of gateway resource 151.

### Implementation Narrative

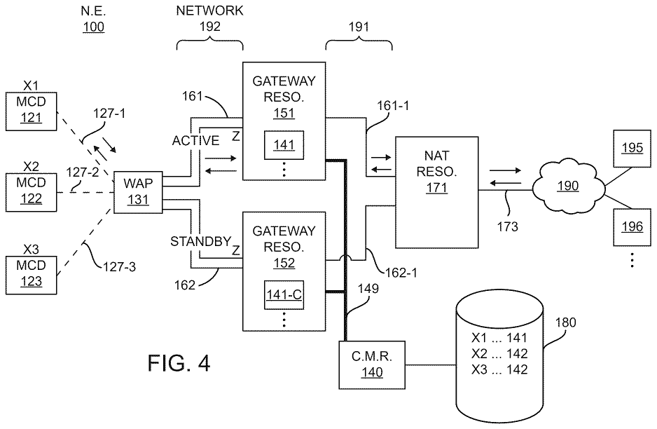

As discussed herein, as shown in FIG. 4, during steady state load conditions, the primary gateway resource 151 receives communications forwarded from the mobile communication device 121 through the wireless access point 131 and the communication path 161. The communications from the mobile communication device 121 are forwarded by the gateway resource 151 for network translation and delivery to the appropriate destination in the network 190.

As previously discussed, implementation of the BNG control plane and corresponding operations executed by the communication management resource 140 ensures that the gateway resource 152 is configured with the same network settings (141) as the gateway resource 151. This maintains synchronization of port mapping information associated with the mobile communication device 121 between the gateway resource 151 and the gateway resource 152. This means that the gateway resource 152 is always ready to take over reception and forwarding of data packets received from the mobile communication device 121 through the wireless access point 131 for appropriate forwarding to the network address translator resource 171.

In a further example, the BNG control plane implemented by the communication management resource 140 continuously builds a look up table including, at a minimum, the wireless access point 131 network address source of the tunnel number assigned as well as the network address such as a MAC address (X1) of the mobile communication device 121 and IP (network) address assigned from the DHCP process. This will always be synchronized between the gateway resource 151 and the gateway resource 152 and corresponding planes.

As previously discussed, the network address translation function implemented by the network address translator resource 171 analyzes incoming traffic from the BNG user plane, matching it against its translation table based on the Mac address (X1) of the user equipment (a.k.a., mobile communication device 121) and the local area network number assigned and the source IP of the tunnel (communication path 161), if used. Note that the tunnel in question here would be a tunnel between a BNG user plane and the network address translation server (such as network address translator resource 171), if used. VLAN or layer two connection could also be used as well as a QinQ mechanism to allow for multiplexing across the network segment between the BNG user plane and the network translation device.

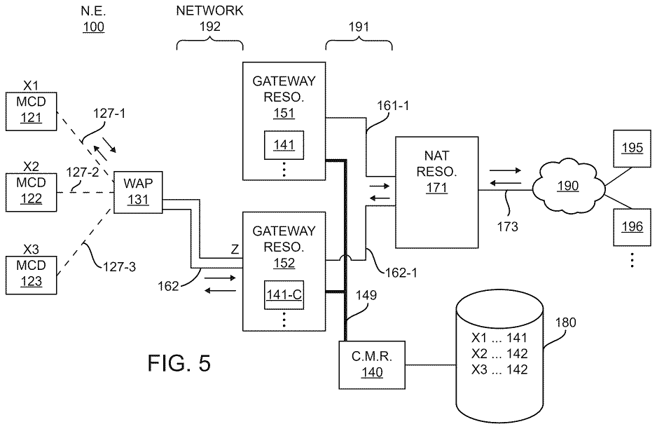

As further shown in FIG. 5, in the event of a failure associated with the communication path 161 and/or the gateway resource 151, the network 192 automatically reroutes all traffic (a.k.a., data packets) from the wireless access point 131 over the communication path 162 to the gateway resource 152. The secondary gateway resource 152, as previously discussed, is configured with the same configuration settings (table state information such as configuration settings 141) as the gateway resource 151 based on operations provided by the communication management resource 140. The secondary gateway resource 152 is thus prepared (based on the synchronization network settings as previously discussed) to service all connections associated with applications of the mobile communication device 121, seamlessly, and forward them to the network address translation function executed by the network address translator resource 171.

In a further example, because there is commonality between the two BNG user planes with respect to the local area network number representing the internal network, the network address X1 such as a Mac address and associated DHCP assigned IPV for internal address when traffic is received from the secondary BNG, the only thing that will change is the source of the BNG user plane West bound interface sending to the network address translation function 171. The network address translation function is executed by the network address translator resource 171 continues to use the public IP and port combination assigned to the internal traffic as was used when the primary BNG user plane was functional. This allows for a seamless failover of the BNG user planes without the need to reset any sockets associated with the mobile communication device 121 and a target one or more server resources 195, 196, etc., in the network 190.

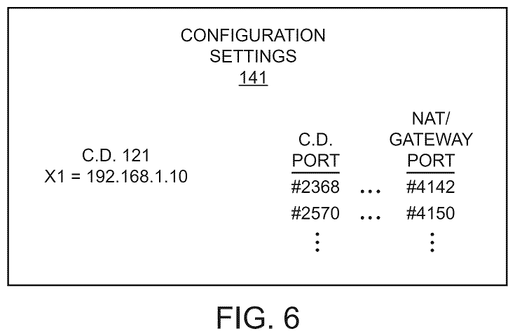

FIG. 6 is an example diagram illustrating configuration settings supporting communication of data packets through multiple debris resources as discussed herein.

In this example, the configuration settings 141 include port to port mapping of ports associated with the communication device 121 to the corresponding ports associated with the gateway resource.

More specifically, the communication device 121 and configuration settings 141 are identified by the network address X1=192.168.1.10 assigned to the communication device 121.

The communication device 121 can be configured to implement or establish any number of sockets (ports) supporting communication (transmission or reception) of data for one or more applications executed on the mobile communication device 121. In this example, the communication device 121 includes/supports the port #2368. As previously discussed, the gateway resource 151/152 and corresponding network address translator resource 171 are configured to support network address translation of transmitting data packets from the communication device 121 outbound from a respective gateway to the network 190. The port #2368 associated with the communication device 121 in this example maps to the corresponding port #4142 as used by the network address translator/gateway resource to communicate in the public network.

Further in this example, the communication device 121 implements the port #2570 to support conveyance of data associated with one or more applications executed on the mobile communication device 121. As previously discussed, the gateway resource 151/152 and corresponding network address translator resource 171 are configured to support network address translation of transmitting data packets from the communication device 121 outbound to the network 190. The port #2570 associated with the communication device 121 in this example maps to the corresponding port #4150 as used by the network address translator/gateway resource to communicate in the public network.

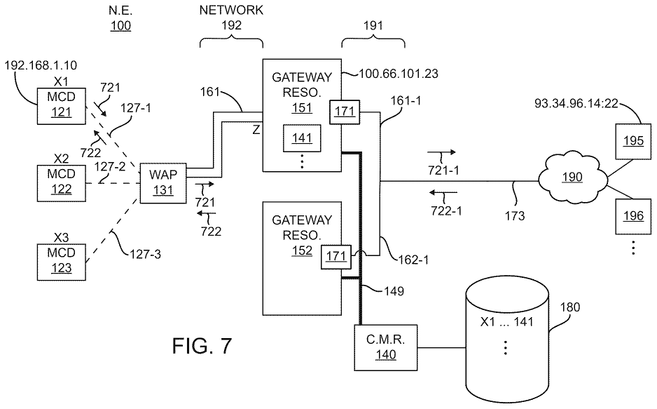

Examples of using the configuration settings 141 via a first communication path and corresponding gateway resource 151 to convey data packets and perform network translation is discussed in FIG. 7.

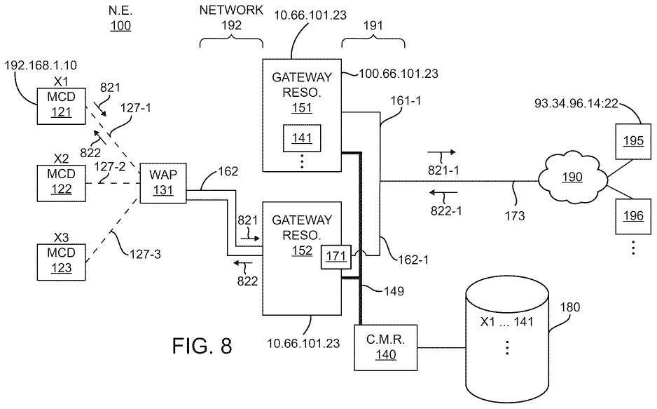

Examples of using the configuration settings 141 via a second communication path and corresponding gateway resource 152 to convey data packets and perform network translation is discussed in FIG. 8.

FIG. 7 is an example diagram illustrating use of the configuration settings to support conveyance of data packets over a combination of a first communication path and a first gateway resource to a remote network as discussed herein.

In this example, the combination of the gateway resource 151 and the network address translator resource 171 implement the configuration settings 141 (see FIG. 6).

More specifically, as shown in FIG. 7, the mobile communication device 121 transmits the communications 721 such as including a first data payload over the wireless communication link 127-1 to the server resource 195. The communications 721 are transmitted from a socket of the mobile communication device 121 such as port #2368 over the wireless communication link 127-1 for delivery to a target server resource 195. Assuming that the server resource 195 is assigned the network address 96.34.96.14, the communications 721 generated by the mobile communication device 121 or other suitable entity include a source network address of X1 (192.168.1.10) plus the port #2368 and a destination network address of 96.34.96.14:22. The communications 721 may further include a first data payload for delivery to the server resource 195.

As previously discussed, the gateway resource 151 and the network address translator resource 171 receive the communications 721 destined for delivery to the server resource 195. In a manner as previously discussed, the gateway resource 151 and corresponding network address translator resource 171 translate a combination of the source network address 192.168.1.10 and port #2368 in the received communications 721 into the new source network address 100.66.101.23 and corresponding port #4152 associated with the gateway resource 151. In other words, the network address translator 171 translates the source network address 192.168.1.10 into the new source network address 100.66.101.23 (network address Z of the gateway resource 151) assigned to the gateway resource 151 to produce the respective communication 721-1, which includes the first data payload originally in the communications 721. Additionally, using the configuration settings 141 and corresponding port to port mapping information, the network address translator 171 translates the port #2368 in the received communications 721 into the port #4142 (socket associated with the gateway resource 151) to produce the communication 721-1.

In such an instance, based on the translation, the communication 721-1 includes the source network address 100.66.101.23 (public network address) and corresponding port #4142. The gateway resource 151 transmits the communications 721-1 including the translated source network address and port # over the communication path 173 and corresponding network 190. The network 190 uses the new source network address 100.66.101.23 and the corresponding port #4142 in the communication 721-1 transmitted from the gateway resource 151 to route the communication 721-1 and corresponding first data payload to the server resource 195.

In a reverse direction, the communications 722-1 transmitted from the server resource 195 through the gateway resource 151 to the mobile communication device 121 are translated in accordance with the port mapping information in the configuration settings 141. For example, the server resource 195 can be configured to communicate a respective communication 722-1 over the network 190 to the gateway resource 151 using the destination of 100.66.101.23 and port #4142 for delivery to the mobile communication device 121. The communications 722-1 may further include a source network address of 96.34.96.14 and port #22.

Via the configuration settings 141, the gateway resource and corresponding network address translator 171 translate the destination network address 100.66.101.23 in the received communications 722-1 into the destination network address 192.168.1.10.

Via the configuration settings 141, the gateway resource 151 and corresponding network address translator 171 translate the port #4142 into the port #2368 associated with the mobile communication device 121. The gateway resource 151 produces the communication 722 to include the translated destination network address 100.66.101.23 and corresponding port #2368 for delivery of the corresponding data payload from the server resource 195 to the mobile communication device 121. The communications 722 may further include the source network address of 96.34.96.14 and port #22.

FIG. 8 is an example diagram illustrating use of the configuration settings support conveyance of data packets over a combination of a second communication path and a second gateway resource to a remote network as discussed herein.

As previously discussed, the first communication path including the gateway resource 151 and the communication path 161 may experience a failure. In such an instance, the second communication path including the communication path 162 and the gateway resource 152 provides mobile communication device 121 and wireless access point 131 connectivity to the remote network 190. Alternatively, the gateway resource 151 may be operational. It may be desirable to use the second communication path including the communication path 162 and corresponding gateway resource 152 for load balancing reasons such as because the first communication path including the communication path 161 gateway resource 151 are congested.

In accordance with the synchronization as discussed herein, the communication management resource 140 supplies the configuration settings 141 to the gateway resource 152. As previously discussed, this enables the gateway resource 152 to use the same configuration settings to handle data traffic associated with the mobile communication device 121.

In this example, the combination of the gateway resource 152 and the network address translator resource 171 implement the configuration settings 141 (see FIG. 6) to support forwarding of communications.

More specifically, the mobile communication device 121 transmits the communications 821 over the wireless communication link 127-1 to the server resource 195. The communications 821 are transmitted from a socket of the mobile communication device 121 such as assigned port #2368. Assuming that the server resource 195 is assigned the network address 96.34.96.14, the communications 821 generated by the mobile communication device 121 or other suitable entity include a source network address of X1 (192.168.1.10) plus the port #2368 and a destination network address of 96.34.96.14:22 assigned to the server resource 195 and corresponding socket.

As previously discussed, the gateway resource 152 and the network address translator resource 171 receive the communications 821 destined for delivery to the server resource 195. In a manner as previously discussed, the gateway resource 152 and corresponding network address translator resource 171 translates a combination of the source network address 192.168.1.10 and port #2368 in the communications 821 into the new source network address 100.66.101.23 and corresponding port #4152. In other words, the network address translator 171 translates the source network address 192.168.1.10 into the new source network address 100.66.101.23 (network address Z of the gateway resource 151) to produce the respective communication 821-1. Additionally, the network address translator 171 translates the port #2368 in the received communications 821 into the port #4142 to produce the communication 821-1.

In such an instance, based on the translation, the communication 821-1 includes the source network address 100.66.101.23 (public network address) and corresponding port #4142. The network 190 uses the new source network address 100.66.101.23 and the corresponding port #4142 in the communication 821-1 transmitted from the gateway resource 151 to communicate the gateway resource 151 sending the communication and 821-1.

In a reverse direction, the communications transmitted from the server resource 195 through the gateway resource 152 to the mobile communication device 121 are translated via the port mapping information in the configuration settings 141.

More specifically, in a reverse direction, the communications transmitted from the server resource 195 through the gateway resource 152 to the mobile communication device 121 are translated in accordance with the port and network address mapping information in the configuration settings 141. For example, the server resource 195 can be configured to communicate a respective communication 822-1 over the network 190 to the gateway resource 152 using the destination of 100.66.101.23 and port #4142 for delivery to the mobile communication device 121. The communications 822-1 may further include a source network address of 96.34.96.14 and port #22.

Via the configuration settings 141, the gateway resource 152 and corresponding network address translator 171 translate the destination network address 100.66.101.23 in the communications 822-1 into the destination network address 192.168.1.10. Via the configuration settings 141, the gateway resource 152 and corresponding network address translator 171 translate the port #4142 into the port #2368. The gateway resource 152 produces the communication 822 to include the destination network address 100.66.101.23 and corresponding port #2368 as the source network address associated with the communications 822 for delivery of the corresponding data payload from the server resource 195 to the mobile communication device 121 over the backup path including communication path 162.

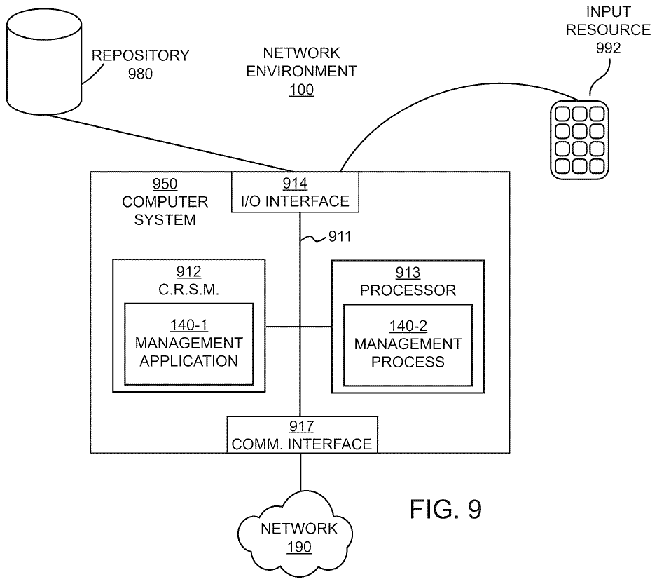

FIG. 9 is an example block diagram of a computer system for implementing any of the operations as previously discussed according to examples herein.

Note that any of the resources (such as communication management resource 140, mobile communication device 121, wireless access point 131, gateway resource 151, gateway resource 152, network address translator resource 171, etc.) as discussed herein can be configured to include computer processor hardware and/or corresponding executable instructions to carry out the different operations as discussed herein.

For example, as shown, computer system 950 of the present example includes interconnect 911 coupling computer readable storage media 912 such as a non-transitory type of media, or computer readable storage hardware (which can be any suitable type of hardware or physical resource in which digital information can be stored and or retrieved), a processor 913 (computer processor hardware), I/O interface 914, and a communications interface 917.

I/O interface(s) 914 supports connectivity to repository 980 and input resource 992.

Computer readable storage medium 912 such as computer readable hardware can be any hardware storage device such as memory, optical storage, hard drive, floppy disk, etc. In one example, the computer readable storage medium 912 stores instructions and/or data.

As shown, computer readable storage media 912 can be encoded with communication management application 140-1 in a respective wireless station to carry out any of the operations as discussed herein.

During operation of one example, processor 913 accesses computer readable storage media 912 via the use of interconnect 911 in order to launch, run, execute, interpret or otherwise perform the instructions in management application 140-1 stored on computer readable storage medium 912. Execution of the communication management application 140-1 produces communication management process 140-2 to carry out any of the operations and/or processes as discussed herein.

Those skilled in the art will understand that the computer system 950 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein.

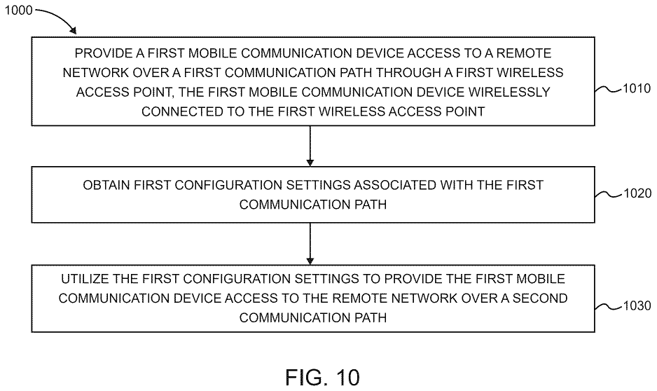

Functionality supported by the different resources will now be discussed via flowchart 1000 in FIG. 10. Note that the steps in the flowchart below can be executed in any suitable order.

FIG. 10 is a flowchart 1000 illustrating an example method according to examples herein. Note that there will be some overlap with respect to concepts as discussed above.

In processing operation 1010, a combination of the wireless access point 131, the communication path 161, the gateway resource 151, and the network address translator resource 171, provide a first mobile communication device access to a remote network 190.

In processing operation 1020, the communication management resource obtains first configuration settings associated with the first communication path.

In processing operation 1030, the communication management resource 140 uses the first configuration settings to provide the first mobile communication device access to the remote network over a second communication path.

Note again that techniques herein are well suited to provide improved wireless connectivity amongst wireless stations. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
providing a first mobile communication device access to a remote network over a first communication path through a first wireless access point, the first mobile communication device wirelessly connected to the first wireless access point;
obtaining first configuration settings associated with the first communication path; and
utilizing the first configuration settings to provide the first mobile communication device access to the remote network over a second communication path.

2. The method as in claim 1 further comprising:
obtaining the first configuration settings via receipt of a unique identity value assigned to the first mobile communication device.

3. The method as in claim 2, wherein utilizing the first configuration settings to provide the first mobile communication device access to the remote network over the second communication path includes:
mapping the unique identity value to the first configuration settings, the first configuration settings used by a first gateway resource in the first communication path; and
communicating the first configuration settings to a second gateway resource in the second communication path.

4. The method as in claim 1, wherein the second communication path is a backup communication path with respect to the first communication path during a condition in which the first communication path is unable to support conveyance of data traffic on behalf of the first mobile communication device.

5. The method as in claim is 4, wherein the first configuration settings are applied by a first gateway resource in the first communication path to support the access to the remote network, the method further comprising:
receiving a query from a second gateway resource supporting the second communication path; and
in response to receiving the query, notifying the second gateway resource to provide the first mobile communication device access through the second communication path using the first configuration settings.

6. The method as in claim 1, wherein the first communication path includes a first secure network tunnel between the first wireless access point and a first gateway resource; and
wherein the second communication path includes a second secure network tunnel between the first wireless access point and a second gateway resource.

7. The method as in claim 6, wherein the first configuration settings indicate at least one port number in which to forward the communications to the remote network.

8. The method as in claim 7, wherein the second communication path is used as a backup communication path with respect to the first communication path during a condition in which the first communication path is unavailable for use by the mobile communication device.

9. The method as in claim 1, wherein the first configuration settings indicate a first pool of port numbers assigned to the first mobile communication device, the first pool of port numbers assigned for use by a first gateway resource associated with the first communication path; and
wherein utilizing the first configuration settings to provide the first mobile communication device access to the remote network over the second communication path includes supplying the first pool of port numbers to a second gateway resource associated with the second communication.

10. The method as in claim 9, wherein synchronization of the first configuration settings for use by both the first gateway resource and the second gateway resource ensure that a public identity associated with data packets forwarded from the first gateway resource and the second gateway resource is the same.

11. A system comprising:
communication management hardware operative to:
provide a first mobile communication device access to a remote network over a first communication path through a first wireless access point, the first mobile communication device wirelessly connected to the first wireless access point;
obtain first configuration settings associated with the first communication path; and
utilize the first configuration settings to provide the first mobile communication device access to the remote network over a second communication path.

12. The system as in claim 11, wherein the communication manager hardware is further operative to:
obtain the first configuration settings via receipt of a unique identity value assigned to the first mobile communication device.

13. The system as in claim 12, wherein the communication manager hardware is further operative to:
map the unique identity value of the first mobile communication device to the first configuration settings, the first configuration settings used by a first gateway resource in the first communication path; and
communicate the first configuration settings to a second gateway resource in the second communication path.

14. The system as in claim 11, wherein the second communication path is a backup communication path with respect to the first communication path during a condition in which the first communication path is unable to support conveyance of data traffic on behalf of the first mobile communication device.

15. The system as in claim 14, wherein the first configuration settings are applied by a first gateway resource in the first communication path to support the access to the remote network, the communication management hardware further operative to:
receive a query from a second gateway resource supporting the second communication path; and
in response to receiving the query, notify the second gateway resource to provide the first mobile communication device access through the second communication path using the first configuration settings.

16. The system as in claim 11, wherein the first communication path includes a first secure network tunnel between the first wireless access point and a first gateway resource; and
wherein the second communication path includes a second secure network tunnel between the first wireless access point and a second gateway resource.

17. The system as in claim 16, wherein the first configuration settings indicate at least one port number in which to forward the communications to the remote network.

18. The system as in claim 17, wherein the second communication path is used as a backup communication path with respect to the first communication path during a condition in which the first communication path is unavailable for use by the first mobile communication device.

19. The system as in claim 11, wherein the first configuration settings indicate a first pool of port numbers assigned to the first mobile communication device, the first pool of port numbers assigned for use by a first gateway resource associated with the first communication path; and
wherein the communication management hardware is further operative to use the first configuration settings to provide the first mobile communication device access to the remote network over the second communication path via supplying the first pool of port numbers to a second gateway resource associated with the second communication.

20. The system as in claim 19, wherein synchronization of the first configuration settings for use by both the first gateway resource and the second gateway resource ensure that a public identity associated with data packets forwarded from the first gateway resource and the second gateway resource is the same.

21. Computer-readable storage hardware having instructions stored thereon, the instructions, when carried out by computer processor hardware, cause the computer processor hardware to:
provide a first mobile communication device access to a remote network over a first communication path through a first wireless access point, the first mobile communication device wirelessly connected to the first wireless access point;
obtain first configuration settings associated with the first communication path; and
utilize the first configuration settings to provide the first mobile communication device access to the remote network over a second communication path.
